(19) United States
(12) Patent Application Publication
(10) Pub. No.: US 2023/0083451 A1
(43) Pub. Date: Mar. 16, 2023

(54) CLOSURE DEVICE FOR PRESERVING AN OPEN BOTTLE OF DISTILLED SPIRITS

(71) Applicants: Francis VENTO, Hickory, NC (US); Larry NAPOLITANO, JR., Belmont, NC (US)

(72) Inventors: Francis VENTO, Hickory, NC (US); Larry NAPOLITANO, JR., Belmont, NC (US)

(21) Appl. No.: 17/471,248

(22) Filed: Sep. 10, 2021

(51) Int. Cl. B65D 83/32; B65D 83/62; A47G 19/22; B65D 47/06

(52) U.S. Cl. CPC B65D 83/32; B65D 83/62; A47G 19/2227; B65D 47/06; B65D 2203/12; A47G 2019/2238

(57) ABSTRACT

A closure device for sealing a distilled spirits bottle. The closure device has a pair of channels. A first channel extends through the center of the closure device and acts as an air passage. A second channel is arranged along an exterior portion of the rim of the closure devices and extends through the closure device for pouring. A telescoping backbone through which the air passage is extended connects with the bottom of the first channel in the closure device and descends into the bottle. The telescoping backbone can be altered in height to accommodate various sizes of bottle. A tapered bladder extends around the telescoping backbone. The bladder fills an interior portion of the air bladder with fluid first, thereby causing liquid contents of the bottle to raise to a desired level, or fill line.

### CROSS-REFERENCE TO RELATED APPLICATIONS

This patent application claims the benefit of and priority to U.S. Provisional Patent Application Ser. No. 63/076,550 filed Sep. 10, 2020, entitled “Closure Device For Preserving An Open Bottle Of Distilled Spirits”, which is hereby incorporated in its entirety.

### BACKGROUND

The application generally relates to closures for distilled spirits containers. The application relates more specifically to a means for preserving the unique taste and smell associated with a distilled spirit, i.e. whisky, by preventing the effects of dissipation upon an opened bottle of distilled spirit.

All distilled spirits are comprised of three main components: water, ethanol, and a variety of different congeners. Congeners include chemical compounds such as aldehydes, esters, fusel oils, lactones, phenols, ketones, and terpenes. It is the congeners which give a distilled spirit its characteristic smell and taste.

The smell of a spirit is down to dissipation of the base components of the spirit. Dissipation is the process by which these base components—the water, ethanol, and congeners—change from a liquid to a gaseous form. Due to their different volatilities, these molecules all dissipate at different rates, with ethanol and congeners dissipating at a much faster rate. The dissipation of these molecules from a poured spirit allows an individual to smell the unique scent profile of the spirit. See, e.g., FIG. 3.

The dissipation process occurs quickly in a sealed container. Once the bottle of spirit is opened, all of the gas in the headspace of the container is released into the atmosphere and that headspace will refill preferentially with more dissipated ethanol and congeners after the bottle is closed and stored.

Over time, this withdrawal of ethanol and congeners from the distilled spirit, coupled with the minimal withdrawal of water, will change the taste and smell of the spirit. As the congeners, which provide the key building blocks for a spirit's unique smell and taste, dissipate out of the spirit and thus reduce in total concentration, the smell and taste of a particular spirit will start to change and fade. Also, as the ethanol likewise dissipates and reduces the total concentration of the solution comprising the particular spirit, certain congeners which remain in the solution will start to precipitate out of solution. This is due to certain congeners being soluble only at a higher ethanol concentration. As these congeners precipitate out of solution, they are no longer available in a pour of the spirit. This process further contributes to the changing smell and taste profile of a particular spirit by the effects of dissipation.

Bourbon, for example, has hundreds of different congeners in the bottle which all work together to provide a very unique smell and taste profile which varies from brand to brand, and often bottle to bottle. The only way to preserve this unique smell and taste profile upon opening of a bottle of bourbon is to stop the process of dissipation. Otherwise, the constituent molecules comprising the liquid will be different each time the bottle is opened—changing more rapidly as the liquid is removed, and the headspace is increased, and as the number and frequency of times the bottle is opened increases.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a closure device for a distilled spirits bottle which forms a seal. The closure device has a pair of channels built into it. A first channel extends through the center of the closure device and acts as an air passage. A second channel is arranged along an exterior portion of the rim of the closure devices and extends through the closure device to act a pour spout.

An extendable tube or backbone through which the air passage is extended connects with the bottom of the first channel in the closure device and descends into the bottle. The telescoping backbone can be altered in height to accommodate various sizes of bottle.

A tapered bladder extends around the telescoping backbone. The bladder is designed so as to preferentially fill an interior portion of the bladder with fluid first, thereby causing liquid contents of the bottle to raise to a desired level, i.e. the fill-line. The bladder is comprised of a material which is sufficiently heavy to naturally sink in the liquid when not filled with air or fluid, e.g. silicone.

A separate handheld pump is provided to affix to a top portion of air channel through the closure device for inflation of the air bladder to replace removed liquid contents of the bottle.

Another embodiment relates to a closure device for a distilled spirits bottle with two channels built into the closure device as previously described.

A telescoping backbone connects with the bottom of the first channel in the closure device and descends into the bottle to extend the air passage through the closure device. The telescoping backbone incorporates LED lights into its structure to allow for the bottle to be illuminated from within. The telescoping backbone can be altered in height to accommodate various sizes of bottle.

A tapered bladder extends around the telescoping backbone. The bladder is designed so as to preferentially fill an interior portion of the bladder with fluid, e.g., air, nitrogen, helium, liquid or similar fluid, first, thereby causing liquid contents of the bottle to raise to a desired level, i.e. the fill-line. The bladder is comprised of a material which is sufficiently heavy to naturally sink in the liquid when not filled with air, e.g. silicone.

A separate handheld pump is provided to affix to a top portion of air channel through the closure device for inflation of the bladder to replace removed liquid contents of the bottle.

Certain advantages of the embodiments described herein are that the original amount of headspace present in the unopened bottle of distilled spirits is maintained as the liquid contents are consumed over time. This minimizes the amount of dissipation of the ethanol and congener molecules by limiting the amount of space these molecules can occupy when in their gaseous states.

Additionally, including integral LED lights allows for enthusiast collectors of distilled spirits to illuminate their prize bottles internally without the need for extensive lighting arrangements external to the bottle. These external lighting arrangements can contribute higher amounts of dissipation by increasing the temperature in the immediate environment surrounding the bottle. Furthermore, extensive lighting being directed towards a bottle of distilled spirits leads to a loss of color and to degradation of certain congeners within the spirit. Both of these deleterious effects further negatively impact the smell and taste of a distilled spirit.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 shows an exemplary embodiment of the closure device of the present invention.

FIG. 2 is an image depicting the closure device of FIG. 1 inserted in a spirits bottle, with telescoping backbone, tapered bladder and pumping mechanism.

FIG. 3 shows dissipation of molecules from a poured spirit and smell the unique scent profile of the spirit by an individual.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

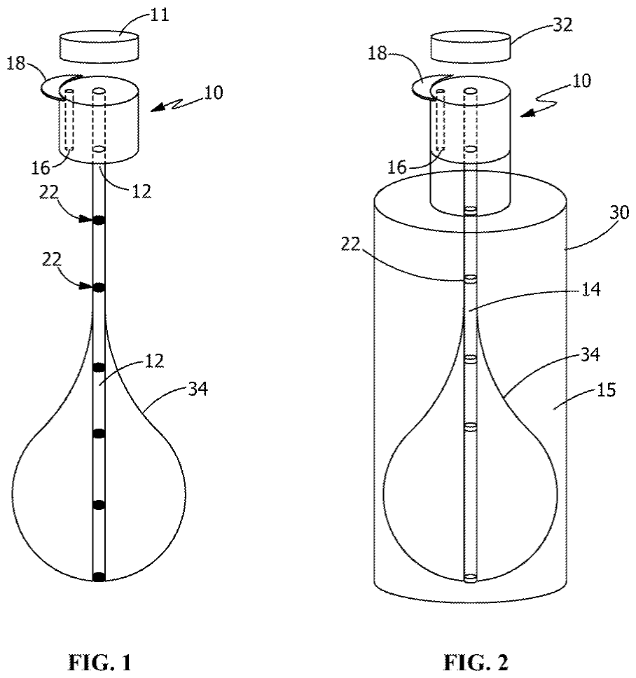

Referring to FIG. 1, the closure device 10 contains an integral first channel 12, which functions as an annular passage extending from the top portion of the closure device 10 through to the bottom portion of the closure device 10. An extendable tube, or backbone 14 is attached to the first channel 12 where it emerges from the bottom portion of the closure device 10. A second channel 16 is situated on an exterior position along the top portion of the closure device 10 and allows for liquid contents 15 of a distilled spirits bottle to pass through said second channel 16 so as to be poured through a spout 18 affixed to the closure device 10. An attachment point 20 for an air pump is affixed to the closure device 10 on its top portion where the first channel 12 exits from the interior of the closure device 10. Tube 14 extends into a bladder 34 disposed within a bottle. Bladder 34 is sealed around tube 14 so that bladder 34 is inflatable when pressurized through tube 14. A cap 11 is removably attachable to closure device 10 to seal the contents of the bottle from the atmosphere when stored.

Closure device 10 may be made of cork, rubber, silicon or other elastomeric, compressible material for forming a near-airtight seal. Telescoping tube 14 is alterable in length to accommodate a range of differently sized bottles. Tube 14 may be weighted on one end so that it naturally extends to a length terminating at a bottom surface of the bottle in which the closure device 10 is inserted. In an alternate embodiment, bladder 34 may optionally fill from the base of a bottle without a backbone, e.g., where the bottom of the bladder or the entire bladder is treated with a more highly dense substance that causes the bladder to sink to the bottom of the glass.

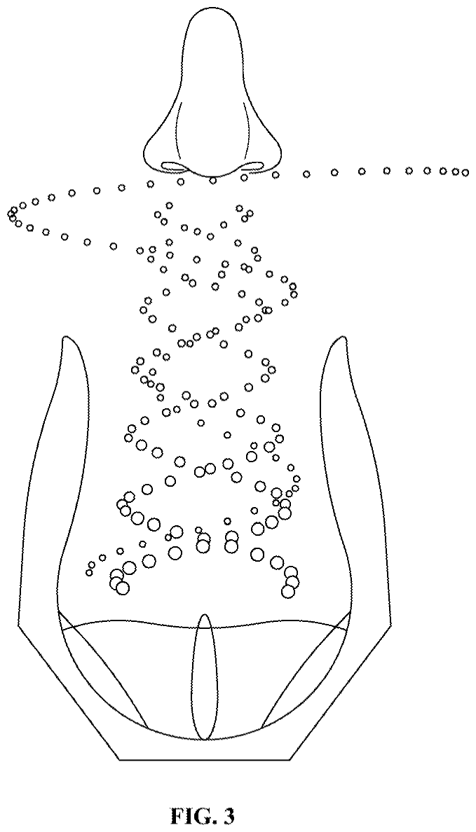

Referring next to FIG. 2, in an exemplary embodiment telescoping tube 14 may include LED lights 22 incorporated directly into the structure of the telescoping tube 14 at spaced intervals, to provide internal illumination of the contents.

Referring next to FIG. 3, a bottle 30 is shown with the closure device 10, the telescoping tube 14, and a tapered bladder 34 inserted into position within the bottle 30. A pump mechanism 32 may be affixed to the closure device 10 to pump air through the first channel 12 and telescoping tube 14 into the tapered bladder 34. Pump mechanism 32 may be a hand-operable pump, a double acting pump or other suitable pressurizing device. In an embodiment pumping mechanism 32 may be attached to closure device 10 via luer lock or similar attachment means to inflate bladder 34 when pumping mechanism 32 is operated. The liquid contents 36 of the bottle 30 are displaced upwards by the inflating tapered bladder 34 so as to maintain the original fill level 38 of the liquid contents 36. The tapered configuration of bladder 34 provides upward displacement of the liquid contents 15, e.g., spirits, to prevent or limit the infusion of air as the contents is drawn down over time.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the closure device for preserving an open bottle of distilled spirits as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A closure device for a distilled spirits bottle comprising:
a first channel and a second channel; the first channel extending vertically through a center axis of the closure device; and the second channel disposed along an exterior portion of a rim of the closure devices;
the closure device configured to seal the bottle;
the first channel providing an air passage; and
the second channel extending through the closure device for a pour spout;
a tube in flow communication with the first channel extending into an interior cavity of the bottle;
a bladder extending around the tube;
wherein the tube is configured to fill an interior portion of the bladder with a fluid, displacing a liquid contents of the bottle and raising the liquid contents to a predetermined level.

2. The device of claim 1, wherein the liquid contents is a distilled spirit.

3. The device of claim 1, wherein the bladder comprises a material composition that sinks in the liquid contents

4. The device of claim 1, wherein the material composition is substantially comprised of silicone.

5. The device of claim 1, further comprising a handheld pump is attachable to a top portion of the first channel, the pump configured to inflate of the bladder to replace a volume of liquid contents removed from the bottle.

6. The device of claim 1, wherein the tube comprises a telescoping annulus, the annulus adjustable to accommodate the vertical length of the bottle.

7. The device of claim 1, wherein the tube further comprises a plurality of LED elements, the LED elements generating a lighted display from within the bottle.

8. A method for preserving an open bottle of distilled spirits, comprising:
inserting a closure device for sealing a liquid contents within the bottle;
attaching an annular tube into a first channel of the closure device; and
inflating a bladder inserted inside the bottle to displace a volume of the bottle after removal of a portion of the liquid contents.
